(19) United States
(12) Patent Application Publication
(10) Pub. No.: US 2026/0292786 A1
(43) Pub. Date: Sep. 24, 2026

(54) DEVICE ORIGINATED AUTONOMOUS TRAFFIC FOR AMBIENT IOT

(71) Applicant: INTERDIGITAL PATENT HOLDINGS, INC., Wilmington, DE (US)

(72) Inventors: Erdem BALA, East Meadow, NY (US); Paul MARINIER, Brossard (CA); Martino FREDA, Laval (CA); Kevin WANUGA, Souderton, PA (US); Senay NEGUSSE, Montreal (CA); Jongwoo HONG, New York, NY (US)

(21) Appl. No.: 19/088,201

(22) Filed: Mar. 24, 2025

(51) Int. Cl. H04W 68/02; H04W 56/00

(52) U.S. Cl. CPC H04W 68/02; H04W 56/001

(57) ABSTRACT

Disclosed procedures, methods, architectures, apparatuses, systems, devices, and computer program products relate to ambient Internet of Things (AIOT), particularly to device originated autonomous traffic for AIOT. In exemplary implementations, an AIOT device transmits a probe signal to indicate that the device has device originated autonomous (DOA) data to be transmitted. The device may transmit the probe signal with preamble repetition or spreading.

### BACKGROUND

The present disclosure is generally directed to the fields of communications, software and encoding, including, for example, to methods, architectures, apparatuses, and systems related to traffic for Internet of Things (IOT) in a communications system, particularly ambient IoT (AIOT).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates the exchange of messages in an AIOT random access framework;

FIG. 3 illustrates backscatter modulation;

FIGS. 4A-4C illustrate various cases in which a signal or message may indicate information relating to a subsequent message in an AIOT scheme;

FIG. 5 illustrates the transmission of probe signals from a device in accordance with sync signals from a reader followed by monitoring by the device for a message from the reader in an AIOT scheme; and

FIG. 6 illustrates an exemplary transmitter arrangement for use in an AIOT scheme.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

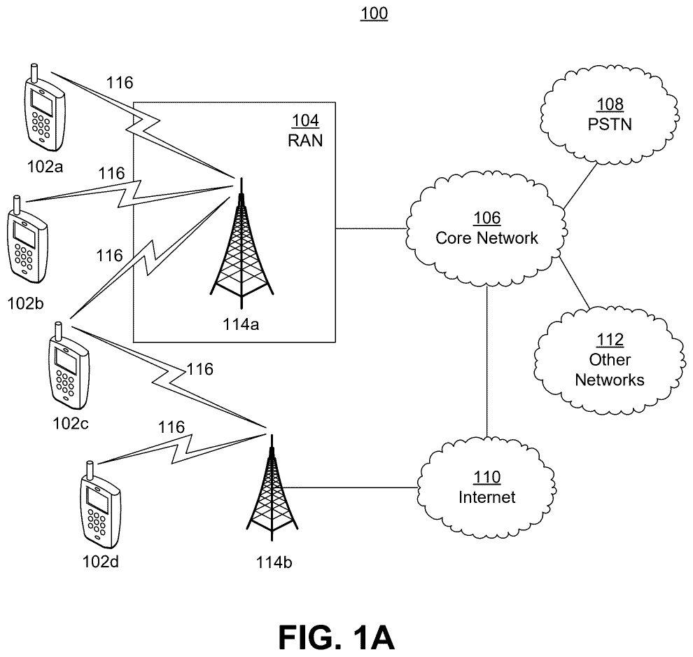

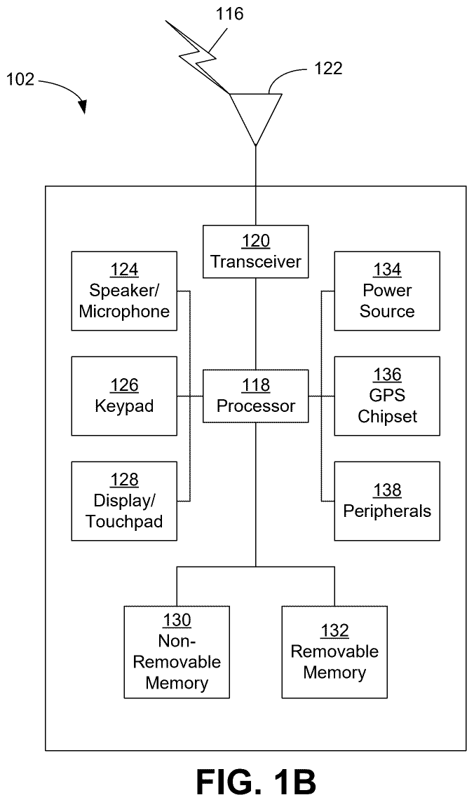

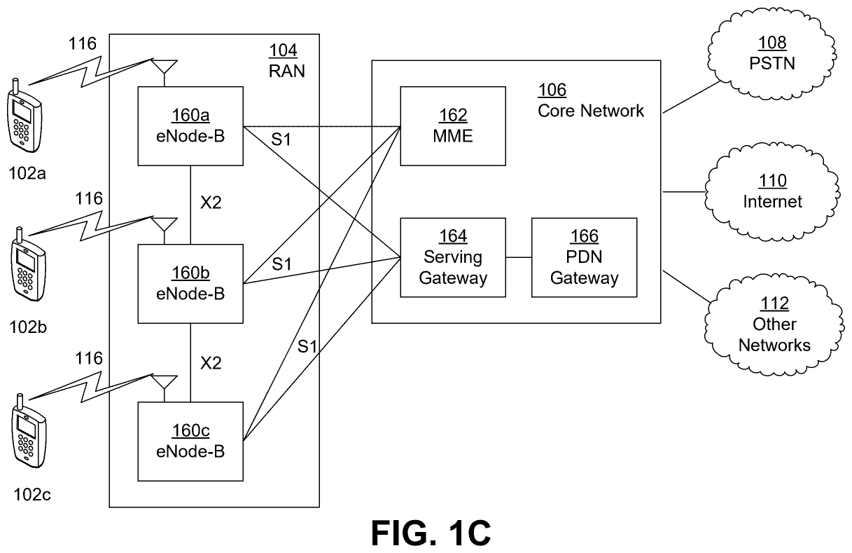

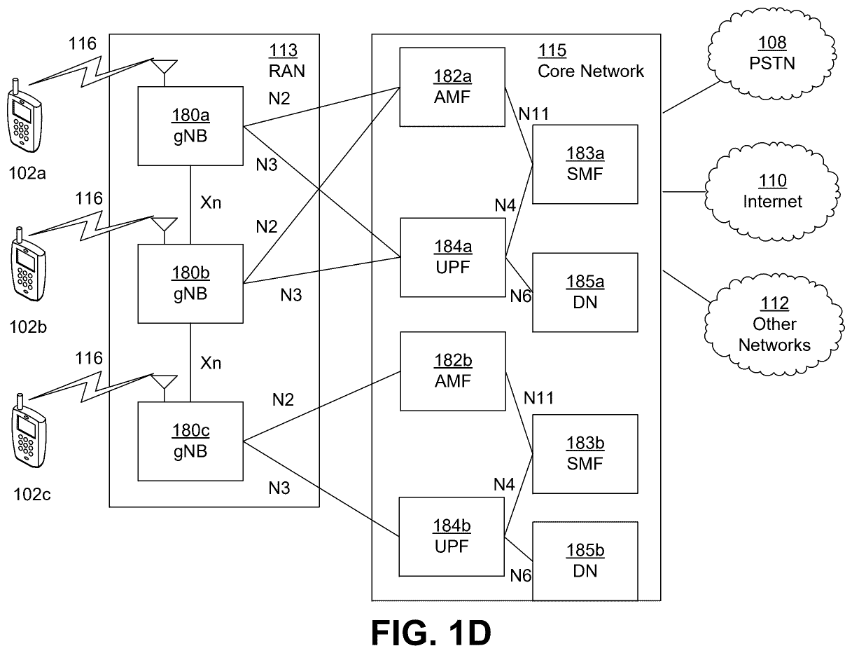

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA,” may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing an NR radio technology, the CN 106 may also be in communication with another RAN (not shown) employing any of a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHZ, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating a RAN 113 and a CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The 3GPP RAN technical specification group has recently started studying ambient Internet of Things (IOT). See 3GPP Technical Report 38.848, “Study on Ambient IoT (Internet of Things) in RAN” (hereinafter Document 1). The devices that are in the scope of the study may have power consumption of about 1 μW to a few hundreds of μW. The devices may transmit using backscattering.

In backscattering, a device reflects a received RF signal after modulating the signal using a baseband signal. Baseband physical layer processing may use line codes for digital baseband modulation. In a line code, digital bits are encoded into one or a sequence of pulses. For example, bit 1 may be encoded as a pulse with level +A and bit 0 may be encoded as a pulse of level 0. Herein, A=1 is assumed without loss of generality. In another example, bit 1 may be encoded as a pulse with level +A and bit 0 may be encoded as a pulse of level −A. In yet another example, bit 1 may be encoded as a half-pulse with level 0 (or −A) followed by a half-pulse with level A and bit 0 may be encoded as a half-pulse with level +A followed by a half-pulse with level 0 (or −A). This last encoding scheme is known as Manchester encoding. See 3GPP Technical Report 38.769, “Study on solutions for Ambient IoT (Internet of Things) in NR” (hereinafter Document 2); 3GPP Technical Report 38.869, “Study on low-power Wake-up Signal and Receiver for NR” (hereinafter Document 3).

An IoT device may use backscatter modulation to transmit data to a receiver. In backscattering, a device does not generate an RF carrier but receives it from an external source and reflects the received RF signal. The baseband signal may be modulated on the reflected RF carrier. This may be achieved by using the impedance mismatch concept. An antenna impedance may be connected to a load impedance at the device. By changing the reflection coefficient (by adjusting the load impedance) over time, the amplitude, frequency, etc. of the reflected signal may be changed. For example, ON-OFF keying modulation may be achieved by using non-reflecting state/OFF signal or reflecting state/ON signal. The RFID specification in EPC® Radio-Frequency Identity Generation-2 UHF RFID Standard (hereinafter Document 4) is based on backscatter communications wherein RFID tags switch the reflection coefficient between two states based on the data being sent. ASK and PSK are supported by the RFID tags. Note that herein, except for the RF carrier signal, all signals discussed are baseband signals unless indicated otherwise.

A small frequency shift may be applied to a line coded signal to shift the signal to a desired frequency. (See Document 2). One baseband processing method to achieve small frequency shift is subcarrier modulation. In this method, a subcarrier signal (that is usually a square wave) is used to multiply the line coded signal. The multiplication may be achieved by a XOR operation (if voltage levels are unipolar) or scalar multiplication (if voltage levels are polar). The resulting signal may then be transmitted using backscatter modulation. With subcarrier modulation, the spectrum of the line coded signal may be shifted in frequency, wherein the shift may be determined by the chip duration of the subcarrier signal.

Another method to shift the spectrum of a Manchester encoded signal is to reduce the codeword duration and repeat the codeword R times within a bit duration where R determines the amount of the frequency shift. In RFID, the D2R link data rate is determined by a parameter referred to as the backscatter link frequency (BLF), which also determines the bandwidth of the transmitted signal. (See Document 4.)

### Radio Frequency Identification (RFID)

RFID is typically used currently for applications relating to asset identification. (See Document 4.)

In an RFID inventory procedure, a reader sends a Query message to energize all or a subset of TAGs. Following a Query message, a TAG selects a random number between 0 and 2Q-1, wherein the number Q is signaled in the Query message and determines the number of slots defined for the procedure. At each transmission of a QueryRep message (which indicates a new slot), the TAG decrements its counter until the counter reaches 0. When the counter reaches 0 the TAG initiates a contention resolution procedure which consists of transmitting a random device ID to the reader and waiting for confirmation of the device ID from the reader (to address possible collision between multiple devices selecting the same random number). Then the device transmits inventory data to the reader (e.g., a product code). For a device that has passed contention resolution, the reader can send multiple commands (such as read/write), to which the TAG should respond.

### Random Access in Ambient IoT (AIOT)

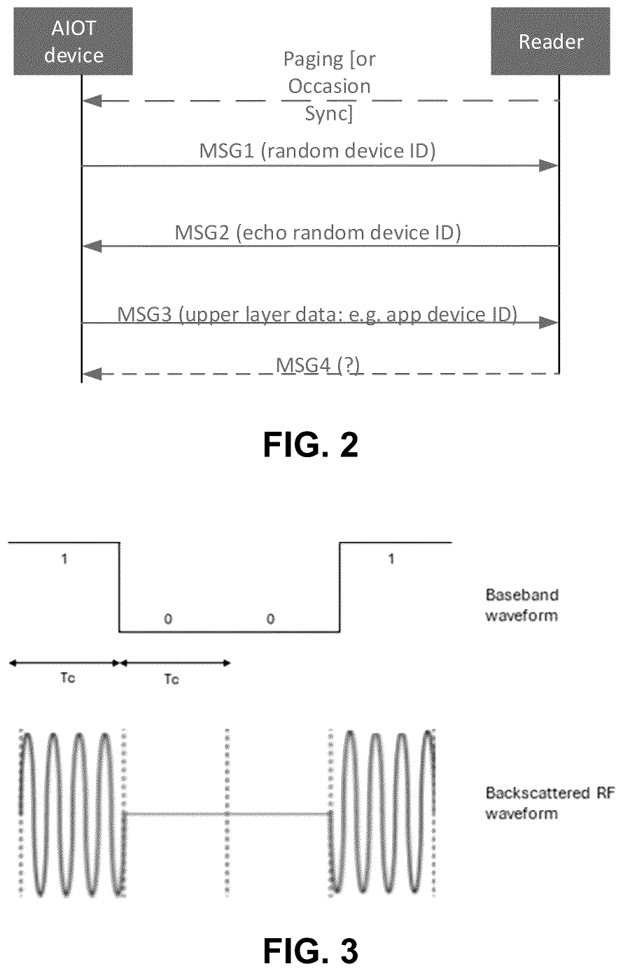

The AIOT random access framework is shown in FIG. 2.

As shown in FIG. 2, the reader sends a paging message and a set of occasion synchronization messages. The paging message provides the device IDs of the devices to respond, i.e., the paging message selects the devices to join the inventory round. The occasion synchronization messages configure/delimit the random-access occasions for transmissions by the AIOT devices.

An AIOT device selects an occasion (using at least slotted ALOHA as the baseline) and transmits a random device ID in MSG1.

The reader, upon successful reception of MSG1, transmits MSG2 by including in MSG2 the device ID received in MSG1.

If the AIOT device receives the echoed random device ID in MSG2, it transmits MSG3 which contains upper layer data (e.g., an application layer device ID).

MSG4 may be transmitted by the reader (e.g., for subsequent command transmission), but the understanding is that contention is already resolved at MSG2 transmission.

The reader may be a gNB, a UE, or another wireless device. The methods described herein may not be limited to IoT devices performing backscattering. They may also be applicable to IoT devices that can generate an RF carrier (that do not need an external carrier), and other wireless devices.

The reader may use an On-Off Keying (OOK) modulated signal to transmit a baseband signal to a device. The baseband signal may be a line encoded signal. For 3GPP Ambient IoT, it has been agreed that an OFDM-based OOK waveform with subcarrier spacing of 15 kHz may be used for Reader-to-Device (R2D) transmission. (See Document 3). Device-to-Reader transmission may be referred to as D2R. The physical channels from the reader and from the device may be referred to as Physical Reader-to-Device Channel (PRDCH) and Physical Device-to-Reader Channel (PDRCH).

In the current AIOT framework, a reader initiates an inventory round and during the inventory round an IoT device responds to a message from the reader. But in other use cases, for example where a device is a sensor performing measurements, traffic may be originated at the device autonomously: device originated-autonomous (DOA). If the current framework is used, this may result in delay/latency. A problem, then, is how to transmit DOA data to a reader.

In exemplary implementations in accordance with one or more proposed solutions, an AIOT device transmits a sequence to a reader multiple times, wherein the timing of the transmission may be based on a small transmission from the reader, referred to a reader sync signal. The sequence comprises multiple repetitions of a sequence. After transmitting the sequence multiple times, the device monitors the reader-to-device channel for a paging message. If a message is not received, the device performs the same procedure by using a new sequence with a larger number of repetitions.

In exemplary implementations in accordance with a first proposed solution, the device increases the number of repetitions of the sequence with each reader sync signal received up to a maximum value.

In exemplary implementations in accordance with a second proposed solution, the device applies frequency hopping to the sequence transmission (via changing chip duration) with each reader sync signal received. In a further attempt, the device may increase the number of repetitions of the sequence.

Exemplary implementations in accordance with the aforementioned solutions will now be discussed in greater detail.

Herein, the terms device, IoT device, tag may be used interchangeably to mean the AIOT device that is being inventoried/queried by the reader. The term reader refers to the entity which queries the AIOT device. The term reader may refer to a network node or a UE, depending on the context and/or the topology. Methods disclosed herein as applicable to IoT devices may also be used by other wireless devices such as UEs.

FIG. 3 shows an example for backscatter modulation and some related terminology. Using a line encoding scheme, information bit 0 is encoded as a pulse of amplitude 1 followed by a pulse of amplitude 0; and information bit 1 is encoded as a pulse of amplitude 0 followed by a pulse of amplitude 1 (this line code is known as Manchester encoding). A chip may be defined as the smallest unit of pulse and the amplitude of a chip is assumed to be constant over the chip duration Tc. A codeword may be comprised of one or more chips. For example, in FIG. 3, each Manchester codeword is comprised of two chips. The chips may be referred to as line codeword bits (e.g., Manchester codeword bits). For example, it may be said that information bit 0 is encoded as {10} and information bit 1 is encoded as {01}.

The baseband line coded waveform modulates an RF sinusoidal carrier (e.g., a carrier wave). In this example, the amplitude of the backscattered signal is changed depending on the value of the line code chip. For example, when a baseband chip has value 1, the received RF carrier is reflected as it is during the duration of Tc; when a baseband chip has value 0, the received RF carrier is absorbed by the device, and nothing is backscattered.

Herein, inventory or inventory round refers to the overall procedure of a reader triggering access by multiple devices using a sequence of messages (e.g., similar to query, followed by query rep in RFID). Note that in AIOT, an inventory round may be triggered with a paging message and time slots (occasions) may be delimited with a second trigger message. Specifically, the inventory procedure refers to a single round of attempts to have each device respond or attempt to respond with its access ID or perform a RACH procedure. Specifically, the inventory procedure refers to a set of access occasions which may have 0 or at least 1 device respond within the access occasion. Similarly, a DOA round refers to the overall procedure of a reader triggering access by multiple devices wherein the devices may have DOA data.

As used herein, occasion or access occasion refers to the opportunity for device transmission that may be delimited by the transmission of a query rep message (or similar). Specifically, a device may perform transmission in an occasion by performing an AIOT transmission in a defined time following the query rep associated with that transmission. Alternatively, an occasion may consist of both a time aspect and a frequency aspect. Specifically, a device may determine an occasion as a transmission following a specific query rep, and by transmitting on one of a number of frequencies (e.g., FDM). Wherever solutions indicate selection of an occasion, they can apply equivalently to selection of only a time component and/or selection of a frequency component.

Herein, depending on the solution or description, any reference to time can be associated with an absolute time measurement (e.g., seconds, slots, frames, etc.). Alternatively, it can refer to a physical signal, for example, the duration of a chip in the R2D or the D2R channel, or the duration of a chip in an R2D preamble. Alternatively, it can refer to a number of executions of a procedure, possibly triggered by a reader (e.g., number of inventory procedures, number of accesses or RACH procedures, etc.) Alternatively, it can refer to a number of messages, possibly of a specific type, or containing specific information, as described herein, received or transmitted.

Configuration or pre-configuration may refer to any configuration received in a message (e.g., an RRC message, a MAC CE, a PHY layer signal, a data PDU, a control PDU associated with any or a new protocol layer, etc.) received from either a network node, or from another device or UE, or default configuration, configuration by user input, or any other suitable means of configuration.

A device herein may be configured by the reader, whereby the reader may be a network node or a UE. In the case of a UE, the UE may derive the device configuration itself, or receive the device configuration from the network, in which case, the device configuration is relayed from the network to the device by the UE. On the other hand, a UE configuration may be received from a network node (e.g., the gNB).

An exemplary sequence of operations carried out by an AIOT device in exemplary implementations in accordance with the first proposed solution is as follows:

1. Receive an R2D message and determine a frequency resource allocated to device-originated data transmission. This operation may be optional.

2. Determine that no inventory process is ongoing. This operation may be optional.

3. Determine arrival of data at device buffer (e.g., sensor data).

4. Monitor for reception of a reader sync signal.

5. Detect a start indicator that indicates the start of a reader sync signal.

6. Receive a reader sync signal, wherein the signal contains a predetermined signal pattern (e.g., a start indicator), and a payload including an index (counter) value greater than zero, which decreases in successively transmitted reader sync signals.

7A. Generate a preamble of a probe signal, wherein the preamble contains a base sequence, and the base sequence comprises a first sub-sequence and a second sub-sequence.

8A. Transmit the probe signal.

9A. Determine to monitor for reception of, and receive, a further reader sync signal based on the last received counter value;
a. for example, if the received counter value is not zero:
   i. monitor for a further reader sync signal,
   ii. receive the further reader sync signal,
   iii. generate a further preamble of a further probe signal by applying a first repetition factor to the first sub-sequence and a second repetition factor to the second sub-sequence, and
   iv. transmit the further probe signal.

10. Determine, based on the received counter value, to monitor the R2D channel (e.g., that includes an allocation for a device-originated-autonomous transmission) for a response; for example, if the received counter value is zero, monitor the R2D channel for a response within a duration of the transmitted preamble.

11. Transmit a signal based on reception of the R2D channel response;
a. for example, if a response is received, transmit the signal using the received allocation for device originated-autonomous transmission, and
b. if a response is not received, apply a backoff period and monitor for a further reader sync signal.

An exemplary sequence of operations carried out by an AIOT device in exemplary implementations in accordance with the second proposed solution is as follows:

1-6. Similar to operations 1-6 above for the first proposed solution.

7B. Generate a preamble of a probe signal, wherein the preamble contains a base sequence, and the base sequence comprises a first sub-sequence and a second sub-sequence
a. determine a first chip duration for the probe signal (i.e., the preamble and any payload if included),
b. the base sequence comprises a square wave and/or a (potentially line coded) sequence (e.g., an m-sequence).

8B. Transmit the probe signal.

9B. Determine to monitor for reception of, and receive, a further reader sync signal based on the last received counter value;
a. for example, if the received counter value is not zero:
   i. monitor for a further reader sync signal,
   ii. receive the further reader sync signal,
   iii. retransmit the probe signal using a further chip duration for the probe signal.

10-11. Similar to operations 10-11 above for the first proposed solution.

The sub-sequences may be encoded with a line code (e.g., Manchester).

Several aspects of the proposed solutions will now be discussed in greater detail.

In exemplary implementations, the reader may transmit a synchronization (sync) signal. A synchronization signal may also be referred to as a probe signal, a probing signal, an alignment signal, or a timing signal. A synchronization signal may be transmitted by a reader at least to provide a timing reference to a device. A signal may include a message. For example, a sync signal may comprise a preamble and a payload carrying a message. In the following, signal may also refer to a message.

The sync signal may be transmitted periodically within a time interval. The network may indicate to the reader (e.g., by a gNB) when to start transmitting the sync signal and/or when to stop transmitting the sync signal. The resources to transmit the sync signal may be configured by the network. Sync signal transmission may be activated and/or deactivated by the network.

In exemplary implementations, a transmission of a signal (e.g., a sync signal) or a message (e.g., a paging message to start an inventory procedure, a paging message to start an inventory round for DOA data) may be determined by the reader based on an event, e.g., a measurement event. For example, a reader may monitor a channel within a specific spectrum (e.g., a 1.92 MHz channel in a 900 MHz carrier band) for a specific signal signature, for example one or a plurality of sequences. The time interval in which measurement is performed (e.g., the measurement window), and the signals to monitor for may be configured and/or specified by the network.

In exemplary implementations, when a specific signature is detected with a received signal power (RSRP) above a threshold (as configured by the network, for example), the reader may determine to transmit the signal (e.g., the sync signal) or the message (e.g., the paging message).

In exemplary implementations, the reader may indicate in a first message the timing information of a subsequent message. For example, in a sync message, the reader may indicate the timing of a paging message, e.g., the next paging message. The timing may be indicated in terms of seconds, number of samples, number of chips, the time duration of a physical signal, configured duration (e.g., T), etc. The reference point in time to measure the timing of a second signal/message may be the end of the transmission of a first signal/message.

In exemplary implementations, the reader may indicate in a first message at least one feature of a second message. A feature may be, for example, a type of the second message. For example, the reader may indicate in a sync message the timing information of a paging message and/or the type of the paging message. For example, a paging message may be an inventory paging or a DOA paging message. A feature may be, for example, the type of devices targeted by a message. For example, a paging message may target inventory devices or DOA devices. A feature may be, for example, the type of data requested by a message. For example, a paging message may target inventory data or DOA data.

In exemplary implementations, the reader may transmit a signal, such as a periodic sync signal transmitted in a specific time interval. The signal may indicate the time and/or frequency resources of another message such as a paging message. The signal, for example, may indicate the time T to the next paging message, and the time may be measured from the end of the sync signal.

In exemplary implementations, the signal may indicate a type for a message. For example, the signal may indicate that a message may be a paging message for inventory or a paging message for DOA data. Note that message type may refer to a message ID in this context; for example, 00 may refer to a paging message to start an inventory round, 01 may refer to a paging message to start a DOA round, and 10 may refer to a paging message used for paging inventory and DOA.

The signal may indicate a data and/or traffic type. A device may have a specific type of data to transmit and the device may determine to monitor for or skip monitoring for the indicated message based on the indicated data type. For example, if the device has DOA data to transmit and the signal indicated inventory data, then the device may determine not to monitor for the message. The signal may indicate device type. The signal may indicate a session ID.

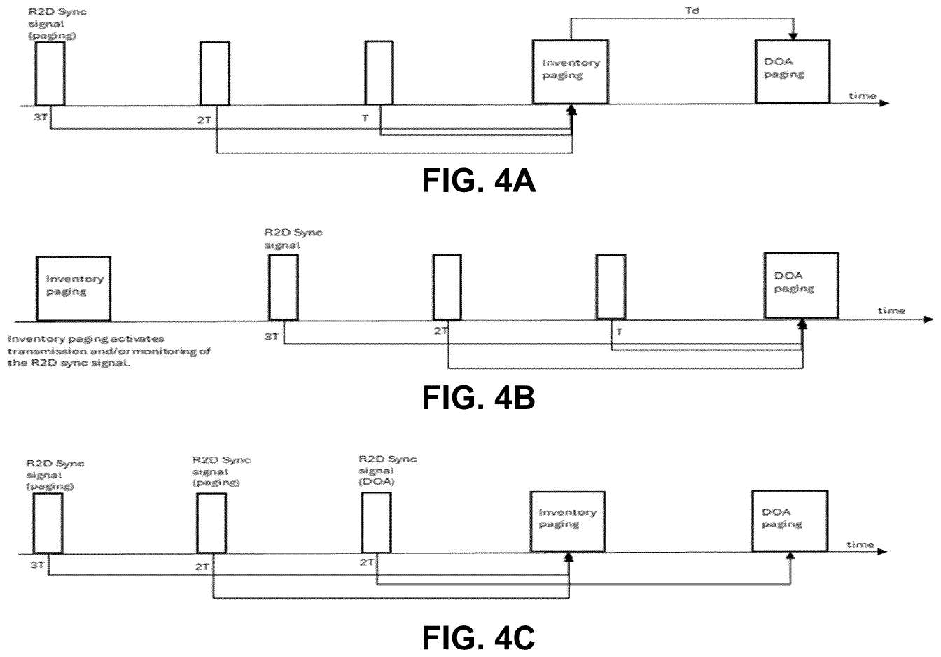

In exemplary implementations, a signal (e.g., a sync signal) may indicate resources for a first message (e.g., an inventory paging message) and the first message may indicate resources for a second message (e.g., a DOA paging message). This is depicted in FIG. 4A. A time Td at which the second message follows the first message may be indicated in the first message.

In exemplary implementations, a first message such as an inventory paging message can activate the transmission and/or monitoring for a second sync signal to indicate a second message such as a DOA paging message. This is depicted in FIG. 4B. This may be done, for example, by including in the first message an indication that a further sync signal will be transmitted, thereby alerting a device receiving the first message to monitor the R2D channel for the further sync signal. Moreover, said indication may specify that the further sync signal will be of a particular type, as will now be described with reference to FIG. 4C.

In exemplary implementations, the reader may transmit more than one type of sync signal. For example, as depicted in FIG. 4C, a first type of sync signal may be used to provide timing for an inventory paging message and a second type of sync signal may be used to provide timing for a DOA paging message. A reader may use one or more of the following to differentiate different types of sync signals:
A message in the signal, including for example a 1-bit indicator.
A physical signal or a feature of a physical signal. For example:
   a different start indicator (SI). For example, a first type of sync signal may have a first SI and a second type of sync signal may have a second SI.
   a different preamble. For example, a first type of sync signal may have a first preamble and a second type of sync signal may have a second preamble.
   a different postamble. For example, a first type of sync signal may have a first postamble and a second type of sync signal may have a second postamble.
   a different chip or set of chips. For example, a first type of sync signal may include at least one chip that is different than a second type of sync signal.

A device may monitor for the sync signal associated with the device data type, device type, etc. For example, a device that has DOA data to transmit may monitor for the sync signal associated with DOA data (e.g., the sync signal providing timing information for DOA paging messages).

The probe signal comprises a preamble. In exemplary implementations, the probe signal preamble may comprise a base sequence. (As generated in operation 7A or 7B, above.) The base sequence may contain a plurality of sub-sequences. For example, a base sequence may comprise one or a plurality of a constant sequence (e.g., a sequence of 1's), a sequence of alternating 1′s and 0's (e.g., 0 , 1, 0 1, . . . ), a Golay sequence, an m-sequence, etc. For example, the sequence may comprise a first sub-sequence of a constant sequence and a second sub-sequence of a Golay sequence.

In exemplary implementations, the sequence may comprise repetitions of the base sequence or repetitions of at least one sub-sequence of the base sequence. For example, the sequence may comprise a first sub-sequence of a constant sequence and repetitions of a second sub-sequence of a Golay sequence. The sequence may comprise a first plurality of repetitions of a first sub-sequence and a second plurality of repetitions of a second sub-sequence. The number of repetitions applied to a sub-sequence of a base sequence to generate the transmitted sequence may be referred to as a repetition factor. The repetition factors applied to a first and second sub-sequence may be different.

The device may perform the following for transmission of a sequence:
Encode the sequence bits using a line code (e.g., Manchester encoding, Non Return to Zero encoding, etc.) In exemplary implementations, the device may select a sequence randomly from a set of available sequences. Alternatively, the device may be configured with a sequence. In exemplary implementations, the device does not apply line coding to some or all of the sequence bits. For example, if a sub-sequence comprises alternating 1s and 0s, the device may not apply line coding and the sub-sequence becomes a square wave after modulation.
Modulate each of the bits of the line code codeword (e.g., the Manchester codeword), or the unencoded sequence bits (in which line coding is not applied). The device may use OOK modulation, BPSK, etc. Note that after applying modulation, the baseband signal comprises chips of a specific duration wherein the values of the chips depend on the bit values.
Transmit the modulated bits.

The chip duration (or chip rate) of a sequence (or of a sub-sequence) may be determined by at least one of the following:
Indicated by a reader, in a R2D message such as a paging message.
Determined as a function of available transmission bandwidth (e.g., chip duration: Tc=1/BW).
Selected randomly (e.g., from a set of values).
Determined based on a device feature and/or capability (e.g., device type, device capability, max SFO).
Determined based on a data/traffic feature (e.g., data priority).
Determined based on a device status (e.g., energy status).

In exemplary implementations, the probe signal may comprise a payload, e.g., at least one information bit. For example, the payload may be a device ID or part of a device ID, an indicator (e.g., a 1-bit indicator transmitted by the device to indicate that there is a device requesting transmission resources), etc. In exemplary implementations, the probe signal may comprise a preamble with a sequence and a payload with a device ID.

In exemplary implementations, a device may transmit a probe signal to a reader (as in operation 8A or 8B above). A device may be triggered to transmit a probe signal by the reception of a transmission from a reader, such as a sync signal. The monitoring by the device for a transmission from the reader and/or the transmission by the device of a probe signal may be triggered by an indication from the MAC layer or a higher layer of the device. In the following, a device probe signal may also be referred to, for example, as a wake-up signal (e.g., to wake up the reader). As mentioned, the probe signal comprises a preamble and may comprise a payload (e.g., information bits). The preamble and/or payload of the probe signal may comprise a sequence.

In exemplary implementations, a sync signal may indicate resources (time and/or frequency resources) for a device to transmit a probe signal to a reader. For example, a time resource may be defined as an interval starting at some time (t1) following the end of the sync signal during which the device may transmit a probe signal on the D2R channel, said interval having a duration of a further time (t2). The indication may be explicit and/or implicit. For example, in an explicit indication, a sync signal may include the aforementioned time information (e.g., t1, t2). In an implicit indication, such time information may not be included explicitly in the sync signal, but the indication is treated by the device as an indication to transmit a probe signal in accordance with said time information, wherein the time information is default time information, predetermined, pre-specified, pre-configured, or otherwise known to the device.

A device may wake-up when the energy of an RF signal incident on the device is above a threshold. For example, the RF signal may be a carrier wave transmitted by a reader or another node in the network. After the device wakes-up, it may monitor the R2D channel for a known signal signature, such as the start indicator of a sync signal transmitted by a reader. When a start indicator signal is detected, the device may continue monitoring the R2D channel.

In exemplary implementations, the device may monitor for a (potentially) periodic signal (e.g., sync signals) transmitted by the reader. A sync signal may carry an index value, such as in a message. A device receiving the sync signal may use the index value to update a counter. For example, a device may set the counter to the index value. The sync message may include an indication for the type of the sync message. For example, the indication may indicate whether the sync signal provides timing information for an inventory paging message or a DOA paging message.

In exemplary implementations, the reader may transmit in each sync signal an index value which decreases with each successively transmitted sync signal. The device may set a counter to the index value or use the index as a counter, depending on implementation. When the counter value attains a specific value (e.g., zero), then the device may be triggered to transmit a probe signal. (It should be noted that the index value, or counter, may increase with successively transmitted sync signals and that the value associated with the aforementioned triggering may be some other, e.g., non-zero, value.)

In exemplary implementations, the device may monitor the R2D channel for sync signals transmitted by the reader and transmit a probe signal after every sync signal.

In exemplary implementations, the device may monitor the R2D channel for sync signals transmitted by the reader and transmit a probe signal after one or more randomly selected sync signals.

In exemplary implementations, the device may monitor the R2D channel for sync signals transmitted by the reader and transmit a probe signal after a plurality of sync signals.

In exemplary implementations, if a new sync signal is not detected within a predetermined time interval, then the device may start monitoring the R2D channel for a paging message instead.

In exemplary implementations, the device may determine a repetition factor applied to a probe signal sequence (e.g., base sequence, sub-sequence) based on one or more of the following:
A signal received from the reader, such as, for example, a sync signal. In one scenario, a device may wake-up (for example when it has sufficient energy), start monitoring the R2D channel, and may receive a sync signal. The sync signal may be one of several sync signals transmitted by the reader within a time interval. The device may set the number of repetitions to an initial value. Subsequently, with each newly received sync signal, the device may increase the number of repetitions (e.g., by one or by another integer), and transmit the sequence with the new number of repetitions. The device may increase the number of repetitions up to a maximum value and may not increase the number beyond that value. Note that this and other disclosed procedures may apply separately to sub-sequences of a sequence and with different parameters. For example, the device may not increase the repetition factor of a first sub-sequence and may increase the repetition factor of a second sub-sequence. In another example, the maximum number of repetitions may be different for first and second sub-sequences. In another example, the device may apply a separate number of repetitions to a payload (if it exists).
The repetition factor may be determined as a function of a feature and/or a message in the sync signal; for example, as a function of the index value in the sync signal or value of the counter at the device. For example, if the counter value is c, the repetition factor may be r=max(L, mod(c, K)) where L is a maximum value and K is a parameter which may be determined by the device, or specified, indicated, or configured by the reader.
Data/traffic priority. For example, for high priority data, the device may transmit with the maximum value L always, or set the initial repetition factor to a higher value, or determine L as a function of data priority (such as using a larger L for higher priority data than lower priority data).
Note that repetition results in a longer sequence (e.g., to enable more energy collection at the receiver). Instead of applying repetition, the device may increase the length of a sequence. The methods disclosed apply similarly to this case.

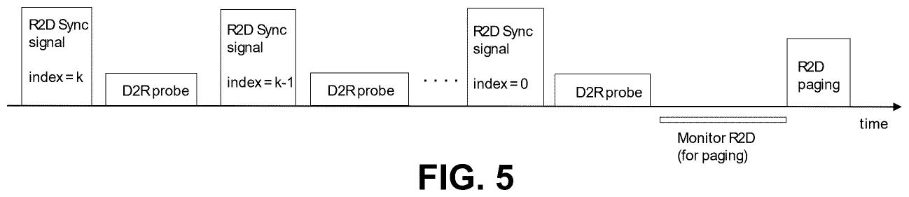

In exemplary implementations, the device may transmit a probe signal each time with the same number of repetitions, such as after every sync signal, as illustrated in FIG. 5, or in a resource indicated by a sync signal. The initial values of the repetition factors may be set randomly (within a maximum value) or may be set to 1. The device may monitor for an R2D message, for example a paging message. If a paging message is received, the device may join the round indicated by the paging message (e.g., a DOA round). If a paging message is not received, the device may increase the repetition factors, monitor for a sync signal, and transmit the probe signal with the updated repetition factors.

In exemplary implementations, the spectrum of the probe signal may be shifted to a frequency using a small frequency shift approach (e.g., by repeating a Manchester codeword R times within a bit duration, or by multiplying a signal with a carrier such as a square wave wherein the carrier may have R periods within a bit period). In exemplary implementations, the device may use a randomly selected frequency (e.g., a randomly selected R value) for each transmission of the probe signal. For example, with each reader sync signal received, the device may transmit the probe signal with an updated R value. In one solution, the device may choose the R value by cycling through a set of R values. For example, if the R values are [2 4 8], then the device may apply R value 4, 2, 4, 8, . . . , etc. in sequence. (Device selects R=4 as the initial R value for the first transmission and then cycles through the set of values for the subsequent transmissions).

In exemplary implementations, generating the probe signal may include applying a spreading operation to the probe signal, e.g., by spreading probe signal bits. The spreading operation may be applied to the probe signal preamble, and if the probe signal includes a payload, to the probe signal payload as well.

Spreading of a bit may be performed by multiplying the bit (e.g., using XOR) with a spreading sequence. The ratio of the spreading sequence chip rate to the data symbol (e.g., data bit) rate may be referred to as the spreading factor (SF). For example, for a first bit duration of Tb, if the number of spreading sequence chips is N, then the SF is said to be N. For a SF of 2N, either the bit duration may be increased to 2 Tb (i.e., lower data rate) or the spreading sequence chip duration may be reduced by half, wherein changing the spreading sequence chip rate results in a change in the occupied bandwidth.

A device may perform the following steps to generate a probe signal (other additional steps are not precluded):
Receive information bits (e.g., from a higher layer such as the MAC layer), add CRC (optionally), and apply channel encoding (optionally), resulting in K bits bi, where i=0, . . . , K−1. The information bits may be placed in a payload of the probe signal.
Multiply each bit of the probe signal with a spreading sequence. For example, if the spreading sequence is c of length N, then the output of the spreading operation of bit bi can be written as [bᵢc₀ bᵢc₁ bᵢc₂ . . . bᵢc_{N-1}].
Encode the spread bits (i.e., each of bᵢcⱼ) using a line code (e.g., Manchester encoding).
Modulate each of the line coded (e.g., Manchester) bits (e.g., using OOK, or BPSK).
Transmit the modulated bits.

In exemplary implementations, the device may determine a SF based on one or more of the following:
A signal received from the reader, such as for example a sync signal. In one scenario, a device may wake-up (for example when it has sufficient energy), start monitoring the R2D channel, and may receive a sync signal. The sync signal may be one of the sync signals transmitted by the reader within a time interval. The device may set the SF to an initial value. Subsequently, with each newly received sync signal, the device may increase the SF (e.g., by 2×), and transmit the probe signal with the new SF. The device may increase the SF up to a maximum value and may not increase the SF beyond that value. Alternatively, the SF may be set as a function of a feature and/or a message in the sync signal; for example, as a function of the counter/index value in the sync signal. For example, if the counter value is c, SF=max(L, mod(c, K)) where L is a maximum value and K is a parameter which may be determined by the device, or specified, indicated, or configured by the reader.
The SF may be limited to a maximum value beyond which it cannot be increased.
Data/traffic priority. For example, for high priority data, the device may always transmit using the maximum value L, or set the initial value to a higher value, or determine L as a function of data priority.

In exemplary implementations, the device may transmit a probe signal each time with the same SF, such as, for example, after every sync signal or in a resource indicated by a sync signal. The initial value of the SF may be set randomly (within a maximum value) or may be set to a fixed value. The device may monitor for an R2D message, for example a paging message. If a paging message is received, the device may join the DOA round indicated by the paging message. If a paging message is not received, the device may increase the SF, monitor for a sync signal, and transmit the probe signal with the updated SF.

### Transmitter

In exemplary implementations, a transmitter (e.g., a device, a UE, a reader, a gNB) may multiplex symbols belonging to different modulation schemes before applying a DFT precoding. For example, a transmitter may multiplex OOK modulation symbols and PSK/QAM modulation symbols.

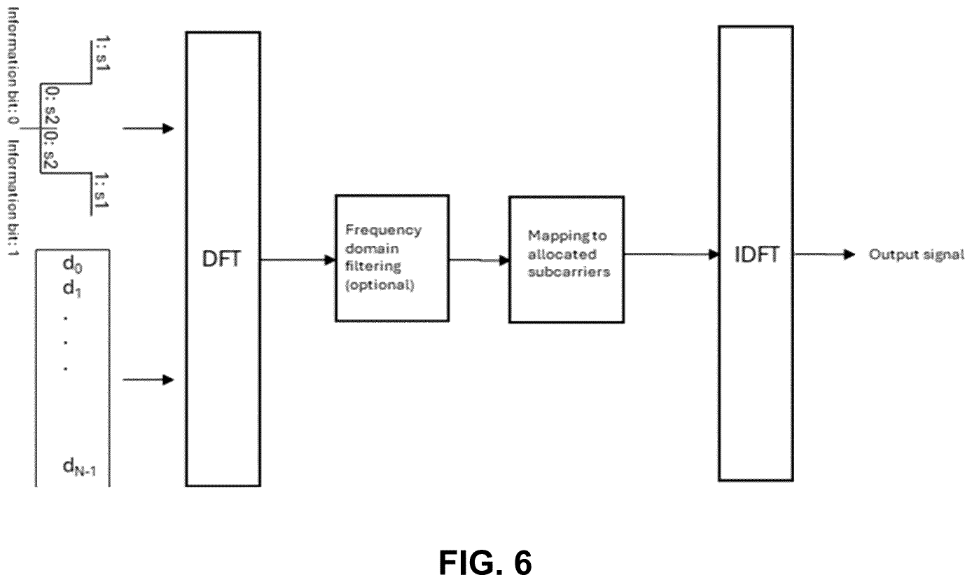

FIG. 6 shows an example of such an arrangement (other operations such as cyclic prefix addition are not precluded). Two bits are first encoded using Manchester encoding resulting in a first codeword {10} and a second codeword {01}. The bit “1” of the Manchester codeword may be represented as a sequence of symbols s1. For example, the “1” chip may be represented as a sequence s1 of 1s, or a sequence such as a Zadoff-Chu sequence. The “0” chip may be represented as a sequence s2 of zeros. If the length of a sequence is L, then in this example, 4 L inputs of the DFT block are allocated to the OOK. The number of PSK/QAM modulation symbols in this example is N, d₀ to d_{N-1}. Note that in this example, a single DFT-s-OFDM symbol generation is shown. In general, data may be mapped to multiple symbols, e.g., over a slot as in 3GPP NR.

In exemplary implementations, the OOK signal may be received by a receiver and the data transmitted with OOK modulation may be used by the receiver as an indication whether to perform receive processing (e.g., channel decoding) to receive the PSK/QAM modulated data. In exemplary implementations, a transmitter may multiplex different types of data. For example, an ACK/NACK bit may be transmitted using OOK modulation while user data may be transmitted using PSK/QAM modulation.

In exemplary implementations, a transmitter may multiplex different types of modulation symbols, as shown in FIG. 6. In one use case, the transmitter (e.g., a gNB, a reader) may send a first modulation data to a first receiver and a second modulation data to a second receiver. The transmitter may indicate to the receivers scheduling parameters so that the receivers may be able to receive the corresponding data.

In another use case, a first transmitter (e.g., a UE, an IoT device) may send a first modulation data and a second transmitter may send a second modulation data wherein the transmitters use the same frequency resources but the data are separated by using non-overlapping inputs of a DFT processing block. A network element such as a gNB may indicate to the transmitters scheduling parameters so that the transmitters may be able to transmit the corresponding data in allocated resources.

At least one of the following may be indicated as part of scheduling parameters:
Frequency resources: for example, the indices of the subcarriers (e.g., RBs) allocated.
DFT size.
The number of segments pre-DFT and/or segment size. For example, a segment of n samples and k segments may refer to a DFT size of k×n.
DFT input indices allocated per modulation data (note that for multiple transmitter cases, this may mean the DFT input indices per transmitter). For example, for a DFT size of D DFT input samples 0: D/2-1 may be allocated to a first modulation data and DFT input samples D/2:D-1 may be allocated to a second modulation data. In exemplary implementations, the pre-DFT segments for an allocation may be indicated with a bitmap, wherein the number of bits in the bitmap is equal to the number of pre-DFT segments. In another solution, the scheduling node may indicate, per allocation, the index of a starting segment and the number of segments (or the ending segment).
Chip duration (i.e., the length of a “1”, or “0” chip), chip length, number of samples per chip.
Number of chips (e.g., for OOK modulation).

Note that in exemplary implementations in accordance with the first proposed solution, the device increases the number of repetitions of a sequence transmitted in a probe signal with each reader sync signal received up to a maximum value. And in exemplary implementations in accordance with the second proposed solution, the device applies frequency hopping to the probe signal transmission (e.g., by changing chip duration) with each reader sync signal received.

It is contemplated that said implementations can be combined in a variety of suitable arrangements or orders. For example, an attempt by a device to transmit DOA data in accordance with the first proposed solution may be carried out n1 times, and an attempt by the device to transmit DOA data in accordance with the second proposed solution may be carried out n2 times, in either order, where n1≥1 and n2≥1, until the DOA data is successfully transmitted.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method performed by a wireless transmit/receive unit (WTRU), the method comprising:
transmitting a synchronization signal, wherein the synchronization signal includes an indication for a paging message to be transmitted by the WTRU;
receiving a probe signal from a device responsive to the synchronization signal;
transmitting the paging message; and
receiving a device originated autonomous (DOA) transmission signal from the device responsive to the paging message.

2. The method of claim 1, wherein:
the synchronization signal is a last of a plurality of synchronization signals transmitted by the WTRU,
each of the plurality of synchronization signals includes an index, and
the indication includes the index of the synchronization signal having an indication index value.

3. The method of claim 1, wherein the index of each successively transmitted synchronization signal increases or decreases until the indication index value.

4. The method of claim 1, wherein the indication includes at least one of a time information, a message type, a data type, a device type, or a resource information associated with the paging message.

5. The method of claim 1, wherein the paging message includes a DOA paging message.

6. The method of claim 1, wherein the device is an ambient internet of things (AIOT) device.

7. A wireless transmit/receive unit (WTRU) comprising:
a processor, memory, and transceiver which configure the WTRU to:
transmit a synchronization signal, wherein the synchronization signal includes an indication for a paging message to be transmitted by the WTRU;
receive a probe signal from a device responsive to the synchronization signal;
transmit the paging message; and
receive a device originated autonomous (DOA) transmission signal from the device responsive to the paging message.

8. The WTRU of claim 7, wherein:
the synchronization signal is a last of a plurality of synchronization signals transmitted by the WTRU,
each of the plurality of synchronization signals includes an index, and
the indication includes the index of the synchronization signal having an indication index value.

9. The WTRU of claim 7, wherein the index of each successively transmitted synchronization signal increases or decreases until the indication index value.

10. The WTRU of claim 7, wherein the indication includes at least one of a time information, a message type, a data type, a device type, or a resource information associated with the paging message.

11. The WTRU of claim 7, wherein the paging message includes a DOA paging message.

12. The WTRU of claim 7, wherein the device is an ambient internet of things (AIOT) device.

13. A method performed by a wireless transmit/receive unit (WTRU), the method comprising:
receiving a synchronization signal from a reader, wherein the synchronization signal includes an indication for a paging message to be transmitted by the reader;
transmitting a probe signal;
receiving the paging message; and
transmitting a device originated autonomous (DOA) transmission signal responsive to the paging message.

14. The method of claim 13 comprising monitoring a channel for at least one of the synchronization signal or the paging message.

15. The method of claim 13, wherein the probe signal includes:
a first number of repetitions of a first sub-sequence of a base sequence, and
a second number of repetitions of a second sub-sequence of the base sequence.

16. The method of claim 13, wherein the probe signal includes a sequence and is transmitted with a chip duration.

17. The method of claim 13, comprising:
receiving at least one further synchronization signal before receiving the synchronization signal, and
transmitting at least one further probe signal after:
each of the at least one further synchronization signals, or
one randomly selected synchronization signal of the at least one further synchronization signal.

18. The method of claim 13, wherein the paging message includes a DOA paging message.

19. The method of claim 13, wherein the WTRU is an ambient internet of things (AIOT) device.

20. A wireless transmit/receive unit (WTRU) comprising:
a processor, memory, and transceiver which configure the WTRU to:
receive a synchronization signal from a reader, wherein the synchronization signal includes an indication for a paging message to be transmitted by the reader;
transmit a probe signal;
receive the paging message; and
transmit a device originated autonomous (DOA) transmission signal responsive to the paging message.

21. The WTRU of claim 20, wherein the WTRU is configured to monitor a channel for at least one of the synchronization signal or the paging message.

22. The WTRU of claim 20, wherein the probe signal includes:
a first number of repetitions of a first sub-sequence of a base sequence, and
a second number of repetitions of a second sub-sequence of the base sequence.

23. The WTRU of claim 20, wherein the probe signal includes a sequence and is transmitted with a chip duration.

24. The WTRU of claim 20, wherein the WTRU is configured to:
receive at least one further synchronization signal before receiving the synchronization signal, and
transmit at least one further probe signal after:
each of the at least one further synchronization signals, or
one randomly selected synchronization signal of the at least one further synchronization signal.

25. The WTRU of claim 20, wherein the paging message includes a DOA paging message.

26. The WTRU of claim 20, wherein the WTRU is an ambient internet of things (AIOT) device.
